(19) United States
(12) Patent Application Publication
(10) Pub. No.: US 2024/0291005 A1
(43) Pub. Date: Aug. 29, 2024

(54) FUEL CELL SYSTEM AND METHOD FOR PROVIDING ELECTRICAL ENERGY

(71) Applicant: Robert Bosch GmbH, Stuttgart (DE)

(72) Inventors: Georg Mallebrein, Korntal-Muenchingen (DE); Matthias Rink, Herrenberg (DE)

(21) Appl. No.: 18/567,626

(22) PCT Filed: Jun. 2, 2022
(86) PCT No.: PCT/EP2022/065087

§ 371 Date: Dec. 6, 2023

(30) Foreign Application Priority Data
Jun. 16, 2021 (DE) 10 2021 206 158.3

(51) Int. Cl. H01M 8/0438; H01M 8/04089; H01M 8/04111; H01M 8/04119; H01M 8/04223; H01M 8/0444; H01M 8/04746; H01M 8/0662

(52) U.S. Cl. CPC H01M 8/04425; H01M 8/04097; H01M 8/04111; H01M 8/04179; H01M 8/04231; H01M 8/04447; H01M 8/04462; H01M 8/04753; H01M 8/0662

(57) ABSTRACT

The present invention relates to a fuel cell system (100) for providing electrical energy. The fuel cell system (100) comprises a blower (101) for conveying anode gas, a movement sensor (103) for detecting measurements of a movement of a paddle wheel of the blower (101), and a controller (105). The controller (105) is configured to assign a state of a composition of matter in an anode circuit of the fuel cell system (100) to measured values of the blower (101) detected by the motion sensor (103) in a speed range between a start speed and a predetermined target speed using a predetermined assignment scheme, and to adjust the fuel cell system (100) depending on the assigned state.

### BACKGROUND OF THE INVENTION

Hydrogen-based fuel cells are considered to be the mobility concept of the future, because they emit only water as an exhaust gas and allow for fast refueling times.

A portion of the water generated in the reaction of hydrogen with air on the cathode side of a fuel cell diffuses through a membrane onto the anode side and mixes there with fresh hydrogen that has been fed in. Similarly, the transport of the air constituent nitrogen from the cathode to the anode occurs. Thus, a gas mixture or a composition of matter consisting of hydrogen, nitrogen, and water is produced on the anode side during operation.

In order to ensure a sufficient supply of hydrogen to the fuel cells of a fuel cell system, hydrogen is typically fed in superstoichiometrically. To increase efficiency and reduce hydrogen loss, anode exhaust gas is typically fed back in a recirculation cycle and mixed with fresh hydrogen.

To remove the undesired species of nitrogen and water, the anode circuit of a fuel cell system is periodically purged. For this purpose, a purge valve is opened and at the same time an increased amount of fresh hydrogen is supplied. However, such a purging operation is typically not selective, so that hydrogen is also discharged.

Various topologies are known for designing an anode circuit in which a pressure gradient is generated for building up a recirculation flow with an active blower, such as a compressor and/or passively by means of an ejector, i.e., a so-called “jet pump.”

Upon startup of a fuel cell system, the anode circuit is initially filled with fresh hydrogen, while respective cathode terminating valves remain closed, which is referred to as “flushing.” During flushing, only oxygen available within respective fuel cells is reacted. At the same time, nitrogen and water present in the anode circuit are removed from the anode circuit by opening the purge valve.

The aim is to determine a minimum required duration for a purging operation, as otherwise there is a risk that hydrogen discharged by the purging operation can agglomerate in the exhaust curve of the fuel cell system into an explosive mixture. In order to prevent this, an air compressor or blower is actuated such that the exiting hydrogen is diluted to the point that there is no risk of exploding.

However, it is problematic that, due to the shortage of construction space in vehicles, typically there is no possibility of directly measuring the hydrogen concentration in the anode circuit.

### SUMMARY OF THE INVENTION

In the context of the invention presented, a fuel cell system and a method for operating the fuel cell system are presented. Further features and details of the invention will emerge from the respective subclaims, the description, and the drawings. Of course, features and details described in connection with the fuel cell system according to the invention also apply in connection with the method according to the invention, and respectively vice versa, so that with respect to the disclosure, mutual reference to the individual aspects of the invention is or can always be made.

The invention presented in particular serves to efficiently provide electrical energy through a fuel cell system. In particular, the invention presented serves to efficiently operate a vehicle.

Thus, according to a first aspect of the present invention, a fuel cell system for providing electrical energy is presented. The fuel cell system comprises a blower for conveying anode gas, a motion sensor for measuring a movement of the blower, and a controller. The controller is configured so as to assign a state of a composition of matter in anode circuit of the fuel cell system to measured values detected using the motion sensor in a speed range between a start speed, in particular zero, and a predetermined target speed using a predetermined assignment scheme, and adjust the fuel cell system depending on the assigned state.

In the context of the invention presented, a blower is to be understood as a mechanism for conveying air with an engine and a rotatable paddle wheel, such as a compressor.

In the context of the invention presented, a target speed is to be understood as a speed predetermined for an operation of a blower.

In the context of the invention presented, a state of a composition of matter is to be understood in particular as a concentration distribution and/or an aggregate state of substances of the composition of matter. Accordingly, a state of a composition of matter indicates a chemical and/or physical state of the composition of matter.

In the context of the invention presented, a state of a blower is to be understood, for example, as a speed and/or a momentum for moving a paddle wheel of the blower in a time window.

In the context of the invention presented, an assignment scheme means in particular an assignment table that assigns respective measured values to respective states or is configured so as to assign respective measured values to respective states.

In the context of the invention presented, an anode gas is understood as gas flowing in an anode subsystem of a fuel cell system, e.g., a hydrogen-nitrogen-water mixture.

In the context of the invention presented, a sensor is to be understood in particular as a combination sensor that detects variables that can be evaluated for the movement of the blower provided according to the invention. The following can be understood as a variable: speed, acceleration, torque, jerk, and/or an electrical current supplied to the blower motor.

The invention presented is based on the principle that a resistance arising on a paddle wheel of a blower in the anode circuit of a fuel cell system changes upon a change in speed, particularly when ramping up after a start, changes depending on a state of a composition of matter in an anode circuit of a corresponding fuel cell system. Accordingly, a speed curve of the blower and/or a torque curve for moving the blower when changing the speed, such as during ramping up, in particular during a start operation of the fuel cell system or a start operation of the blower, changes depending on respective substances present in the anode circuit and their concentrations, i.e., a state of a present composition of matter.

Because hydrogen is a low-density gas, it requires a particularly low mechanical resistance, whereas nitrogen is significantly more dense compared to hydrogen and accordingly requires a higher mechanical resistance. Particularly high mechanical resistances result from water, in particular from frozen water.

Due to the interaction between a mechanical resistance caused by respective substances and their concentrations in an anode circuit and a speed curve of a blower operating in the anode circuit, characteristic variables in a speed curve and/or in a torque curve of the blower can be used in order to infer a state of a composition of matter, in particular a hydrogen concentration in the anode circuit.

As soon as a current state of a composition of matter in the anode circuit of a particular fuel cell system is known, the fuel cell system can be adjusted to the current state by, for example, extending or shortening a duration of a purging operation starting from a base value, or selecting a nitrogen concentration in the anode circuit as a function, for example. Accordingly, the duration of the purging operation can be dynamically adjusted and need not be configured to a maximum nitrogen concentration, as is customary in the prior art. By having a dynamically adjusted duration of a purging operation, a corresponding blowing out of hydrogen is minimized and an efficiency of the fuel cell system is maximized.

It can be provided that the controller is configured so as to determine a gradient of the first and second order of the measured values detected in the speed range. It can further be provided that the assignment scheme assigns the respective values of the gradients of the first and second order to corresponding concentration values of hydrogen and/or water and/or nitrogen in the anode circuit.

Using gradients of various orders, characteristic ranges in measured values, in particular in a speed curve and/or a torque curve, such as slopes or decreases, can be shown compressed. In particular, when comparing several gradients of different orders with the assignment scheme provided according to the invention, a reliable detection or differentiation of different states or different composition of matters can take place.

It can be provided that the assignment scheme assigns a state “low hydrogen concentration” to respectively detected measured values when a gradient of the first order of the measured values lies above a predetermined first gradient threshold and a gradient of the second order of the measured values lies below a predetermined second gradient threshold, and the assignment scheme assigns a state “average hydrogen concentration” to respectively detected measured values when the gradient of the second order of the measured values in a speed range takes on values in a speed range that are 50% less than the target speed, which are less than zero and greater than a predetermined negative threshold, and the assignment scheme assigns a state “low hydrogen concentration” to respectively detected measured values when the gradient of the second order of the measured values takes on values in the speed range that are 50% less than the target speed, which are lower than the negative threshold.

In the case of a high hydrogen concentration in the anode circuit, such as a hydrogen concentration >80 vol. %, a speed trajectory of a blower of a fuel cell system is nearly linear and a target speed is achieved after a few seconds. Thus, in this case, a gradient of the first order reaches a maximum value, wherein a gradient of the second order, i.e., a change in the slope, shows only small values up to close to the target speed.

The threshold values provided in the embodiment of the invention can be configured positively or negatively depending on the detected measured values, such that, for example, an inverse behavior of torque values versus speed values can be depicted.

It can therefore be provided that the assignment scheme assigns a state “low hydrogen concentration” to respectively detected rotational speed values when a gradient of the first order of the rotational speed values lies above a predetermined first gradient threshold and a gradient of the second order of the rotational speed values lies below a predetermined second gradient threshold, and the assignment scheme assigns a state “average hydrogen concentration” to respectively detected rotational speed values when the gradient of the second order of the rotational speed values in a speed range takes on values in a speed range that are 50% less than the target speed, which are less than zero and greater than a predetermined negative threshold, and the assignment scheme assigns a state “low hydrogen concentration” to respectively detected rotational speed values when the gradient of the second order of the rotational speed values takes on values in the speed range that are 50% less than the target speed, which are lower than the negative threshold.

Alternatively or additionally, it can be provided that the assignment scheme assigns a state “low hydrogen concentration” to respectively detected torque values when a gradient of the first order of the torque values lies below a predetermined first gradient threshold and a gradient of the second order of the torque values lies above a predetermined second gradient threshold, and the assignment scheme assigns a state “average hydrogen concentration” to respectively detected torque values when the gradient of the second order of the torque values in a torque range takes on values in a speed range that are 50% less than the target torque, which are greater than zero and less than a predetermined negative threshold, and the assignment scheme assigns a state “low hydrogen concentration” to respectively detected torque values when the gradient of the second order of the torque values takes on values in a torque range that are 50% less than the target torque, which are lower than the negative threshold.

In the case of a high hydrogen concentration in the anode circuit, such as a hydrogen concentration >80 vol. %, a speed trajectory of a blower of a fuel cell system is nearly linear and a target speed is achieved after a few seconds. Thus, in this case, a gradient of the first order reaches a maximum value, wherein a gradient of the second order, i.e., a change in the slope, shows only small values up to close to the target speed.

In the case of average hydrogen concentrations, such as 50-70 vol. %, a speed trajectory of a blower of a fuel cell system in a range >50% of the target speed has a buckle such that the speed trajectory or the speed curve becomes flatter and a gradient of the second order becomes negative.

In the case of low hydrogen concentrations, such as 0-50% vol. %, a speed trajectory of a blower of a fuel cell system sharply buckles over approximately 50% of the target speed so that a gradient of the second order assumes a higher negative value. At the same time, it can be observed that, with each purging operation, there is a gradual increase in the speed, such that a gradient of the second order briefly takes on positive values.

It can further be provided that the controller is configured so as to actuate a purge valve of the fuel cell system depending on a detected state of a composition of matter.

By controlling a purge valve depending on a detected state of a composition of matter in the anode circuit of a fuel cell system, the purge valve can be dynamically controlled so that unnecessary discharge of hydrogen is minimized and fuel cell system efficiency is maximized.

It can further be provided that the assignment scheme assigns a state “water in the anode circuit” to the detected measured values when values of a gradient of the first order of the detected measured values fluctuate between positive and negative values, and that the controller is configured so as to actuate the purge valve such that the purge valve periodically opens and closes in the event that the assignment scheme assigns the state “water in the anode circuit” to the respective measured values.

By periodic or pulsed opening and closing of a purge valve with a period of, e.g., a few seconds, in particular between 1 second and 10 seconds, preferably between 3 seconds and 5 seconds, water can be discharged particularly well from a fuel cell system, because with periodic opening and closing, water is driven towards the purge valve. In the case of periodic opening and closing, the purge valve is repeatedly opened for a predetermined duration and closed again for a short intermediate period of similar duration.

It can further be provided that the assignment scheme assigns a state “water in the anode circuit” to detected measured values when values of a gradient of the first order of the detected measured values fluctuate between positive and negative values, and that the controller is configured so as to actuate the purge valve such that the purge valve periodically opens and closes in the event that the assignment scheme assigns the state “water in the anode circuit” to the respective measured values.

It can therefore be provided that the assignment scheme assigns a state “water in the anode circuit” to detected rotational speed values when values of a gradient of the first order of the detected rotational speed values fluctuate between positive and negative values, and that the controller is configured so as to actuate the purge valve such that the purge valve periodically opens and closes in the event that the assignment scheme assigns the state “water in the anode circuit” to the respective rotational speed values.

Alternatively or additionally, it can be provided that the assignment scheme assigns a state “water in the anode circuit” to detected torque values when values of a gradient of the first order of the detected torque values fluctuate between negative and positive values, and that the controller is configured so as to actuate the purge valve such that the purge valve periodically opens and closes in the event that the assignment scheme assigns the state “water in the anode circuit” to the respective torque values.

A low hydrogen concentration in an anode circuit of a fuel cell system means that nitrogen has accumulated in the anode circuit. The increased density of the nitrogen causes a speed of a blower operating in the anode circuit to increase more slowly than at a high hydrogen concentration. This means that a gradient of the first order of measured values detected during the ramping up of the blower lies below a predetermined threshold. However, the first order gradient lies above the threshold value when water is present in the anode circuit.

Further, in a range above 50% of a target speed of a respective blower, a buckling of a speed trajectory occurs such that a gradient of the second order becomes briefly negative. In that case, a purge valve is opened continuously and kept open at least until the blower reaches its target speed. In this range, a hydrogen concentration is typically above 70 vol. %, which is sufficient for a safe start of a fuel cell system.

It can further be provided that the controller is configured so as to open the purge valve continuously until the target speed of the blower is reached in the event that the assignment scheme assigns the state “low hydrogen concentration in the anode circuit” to the detected measured values.

By means of continuous opening of a purge valve, a high concentration of nitrogen can be efficiently lowered, and a correspondingly problem-free operation of a fuel cell system can be enabled.

It can further be provided that the motion sensor, speed sensor, and/or a torque sensor, such as a current sensor, can be for example a current sensor for determining an electrical current flowing to the blower, i.e., a current drawn by the blower.

A torque sensor, i.e., a sensor for determining a torque applied on a paddle wheel of the blower provided according to the present invention, in particular a sensor for determining a current strength, has proven particularly advantageous for determining a torque curve or a torque trajectory of a blower of a fuel cell system.

By way of example, the torque sensor can be integrated into the blower provided according to the invention or configured as an additional or external torque sensor to the blower.

Based on an analysis of gradients of the first and second order of a signal detected by the torque sensor, as well as a time period for reaching a maximum of a signal value detected by the torque sensor during a speed jump or a ramp-up, in particular during an initial ramp-up of the blower, a hydrogen concentration at the start of the speed jump can be inferred and/or a target speed reached can be detected. Alternatively or additionally, by an analysis of signal values detected by the torque sensor, a hydrogen concentration can be inferred after a maximum has been passed.

It can further be provided that the assignment scheme assigns a state “iced purge valve” to the detected measured values when values of a gradient of the second order of the detected measured values lie below a predetermined purge threshold after a purging operation.

It can therefore be provided that the assignment scheme assigns a state “iced purge valve” to detected rotational speed values when values of a gradient of the second order of the detected rotational speed values lie below a predetermined purge threshold after a purging operation.

Alternatively or additionally, it can be provided that the assignment scheme assigns a state “iced purge valve” to detected torque values when values of a gradient of the second order of the detected torque values lie above a predetermined purge threshold after a purging operation.

If a blower speed increases incrementally with each purging operation, this is typically due to the fact that fresh hydrogen flows into an anode circuit through the purging process, for which reason a density of a medium circulating in the anode circuit drops and the blower has to overcome less flow resistance. An actuation of a hydrogen valve for providing hydrogen into the anode circuit is typically done in a pressure-based manner, such that by opening the hydrogen valve, it is attempted to adjust or maintain a target pressure in the anode circuit. If a purge valve is iced, its opening does not result in a pressure drop, which is equalized by the supply of fresh hydrogen. Thus, the hydrogen supply is omitted during a purging operation and the blower speed does not experience a gradual increase, as can be seen by a change in the gradient of the second order of the blower speed. If, in the event of a purging operation, the gradient of the second order of the blower speed does not immediately increase, the purge valve must be assumed to be iced.

According to a second aspect of the invention presented, a method for operating a fuel cell system is provided. The method comprises a determining step for detecting measured values of a blower of the fuel cell system for conveying anode gas in a speed range between a start speed and a predetermined target speed, by means of a motion sensor, an assigning step for assigning measured values detected by the motion sensor in the speed range to a state of a composition of matter in an anode circuit of the fuel cell system using a predetermined assignment scheme, and an adjusting step for adjusting the fuel cell system depending on the state assigned in the assignment step.

The method presented is particularly useful for operating the fuel cell system presented.

It can be provided that the adjusting step comprises an actuation of a purge valve of the fuel cell system.

### BRIEF DESCRIPTION OF THE DRAWINGS

Further advantages, features, and details of the invention will emerge from the following description, in which exemplary embodiments of the invention are described in detail with reference to the drawings. The features mentioned in the claims and in the description can each be essential to the invention individually or in any combination.

The drawings show:

FIG. 1 a schematic construction of a possible configuration of the fuel cell system according to the invention,

FIG. 2 different curves of a speed signal of a blower of a possible configuration of the fuel cell system according to the invention,

FIG. 3 a schematic representation of the possible configuration of the method according to the invention.

### DETAILED DESCRIPTION

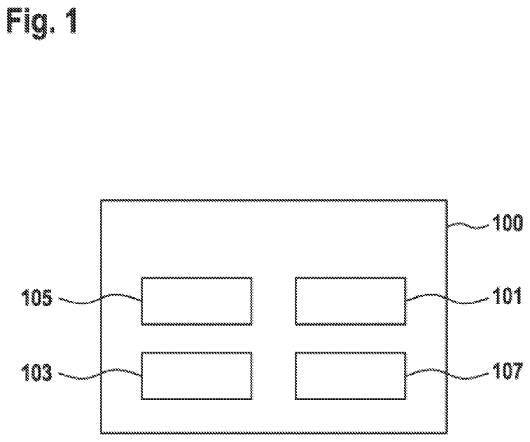

FIG. 1 shows a fuel cell system 100. The fuel cell system 100 comprises a blower 101 for conveying anode gas, a motion sensor 103 for detecting measured values of a movement of a paddle wheel of the blower 101, and a controller 105.

The controller 105 is configured so as to assign a state of a composition of matter in anode circuit of the fuel cell system 100 to measured values of the blower 101 detected using the motion sensor 103 in a speed range between a start speed, in particular zero, and a predetermined target speed using a predetermined assignment scheme, and adjust the fuel cell system 100 depending on the assigned state.

For example, to adjust the fuel cell system 100, the controller 105 can open or close a purge valve 107 of the fuel cell system 100 and, as a result, alter a state of a composition of matter in the anode circuit. In particular, the controller 105 can dynamically alter a duration for which purge valve 107 is opened, depending on a state assigned to respective detected measured values by the assignment scheme.

The measured values detected by the motion sensor 103 can be rotational speed values of a rotational speed of the paddle wheel of the blower and/or torque values of a momentum required to move the paddle wheel. Accordingly, the measured values detected by the motion sensor 103 are dependent on forces acting on the paddle wheel, in particular a resistance of a gas to be moved by the paddle wheel. Because a density and corresponding resistance of a gas changes depending on a concentration of respective components, in particular of hydrogen, the measured values can be used in order to indicate a concentration of the respective components of the gas moved by the paddle wheel. In particular, torque values and/or speed values when accelerating and/or braking the paddle wheel can be characteristic variables for determining a concentration of respective components of the gas. Accordingly, gradients of second and/or third degrees of a change in the measured values can be used in particular in order to determine the concentration of respective components of the gas.

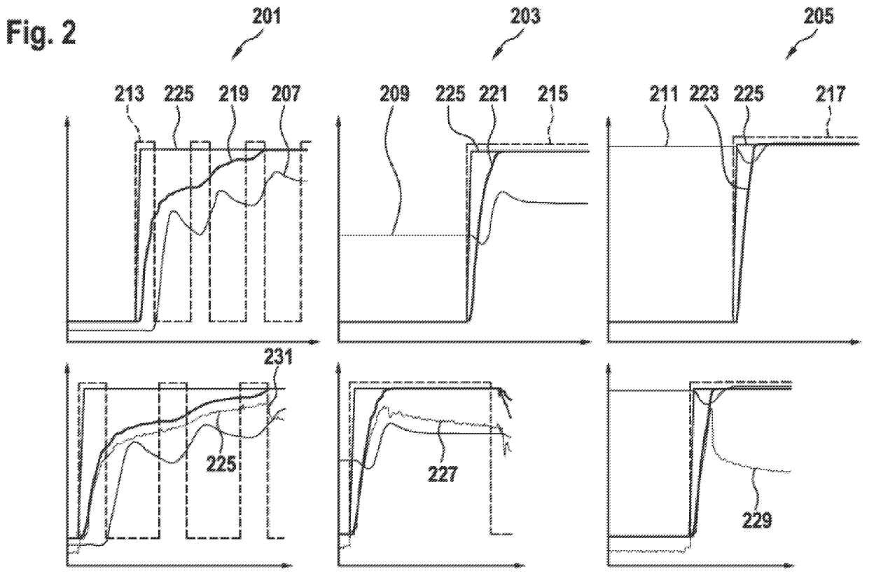

In FIG. 2, diagrams 201, 203, and 205 are shown; in each case, the abscissas span over time and the ordinates span over a speed of a blower operating in an anode circuit of a fuel cell system.

Curves 207, 209, and 211 show a change in a hydrogen concentration in the anode circuit.

Curves 213, 215, and 217 show an activity of a purge valve.

Curves 219, 221, and 223 show a curve of measured values from the motion sensor, such as a speed curve of the blower.

Curve 225 is the same for plots 201, 203, and 205 and indicates a predetermined speed set point of the blower.

When comparing diagrams 201, 203, and 205, it is found that with a low hydrogen concentration according to diagram 207, a rapid increase in speed up to about 50% of the target speed occurs, followed by a slow increase according to diagram 219. Thus, at 50% of the target speed, the curve 219 sharply buckles so that a gradient of the second order of the curve 219 takes on a strongly negative value at this point. At the same time, it can be observed that, with each purging operation, there is a gradual increase in the speed at which the gradient of the second order of the course 219 takes on short-term positive values.

At a mean hydrogen concentration according to curve 209, the curve 221 of the speed in a range of >50% of the target speed buckles such that the curve 221 becomes flatter and the gradient of the second order of the curve 221 becomes negative.

At a high hydrogen concentration according to curve 211, there results a curve 223 of the speed that is nearly linear, and the target speed is achieved after a few seconds. Thus, in this case, the gradient of the first order of the curve 223 achieves a maximum value, and the gradient of the second order of the curve 223 shows only small values up to close to the target speed.

Furthermore, when comparing the diagrams 201, 203, and 205, it can be seen that, depending on the present hydrogen concentration or water content in the anode circuit, distinctly different curves 225, 227, and 229 of an electric current drawn from the blower form.

When the target speed is reached at a point 231, the curve 225 of the electric current will significantly buckle. This buckle can thus be associated with the end of an acceleration operation of the blower. At the same time, it is clear that the curve of the electrical current takes on different insistence values after reaching the target speed, depending on a respective hydrogen concentration. This results from the different hydrogen concentrations leading to different densities and thus to different resistances for the blower. Thus, the analysis of the curve of the electrical current during a ramp-up can be used in order to determine the hydrogen concentration at the start and as a result of a purging operation. Accordingly, using the insistence value after a speed jump, the hydrogen concentration present after the speed jump can be inferred.

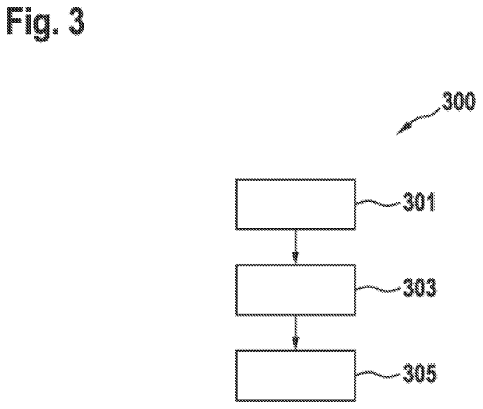

A method 300 for operating a fuel cell system is shown in FIG. 3. The method 300 comprises a determining step 301 for detecting measured values of a movement of a paddle wheel of a blower for conveying anode gas of the fuel cell system in a speed range between a start speed, in particular zero, and a predetermined target speed, by means of a motion sensor, an assigning step 303 for assigning measured values detected by the motion sensor in the speed range to a state of a composition of matter in an anode circuit of the fuel cell system using a predetermined assignment scheme, and an adjusting step 305 for adjusting the fuel cell system depending on the state assigned in the assignment step.

1. A fuel cell system (100) for providing electrical energy,
wherein the fuel cell system (100) comprises:
a blower (101) for conveying anode gas,
a motion sensor (103) for detecting measured values of a movement of a paddle wheel of the blower (101),
a controller (105),
wherein the controller (105) is configured to:
assign a state of a composition of matter in anode circuit of the fuel cell system (100) to measured values of the blower (101) detected using the motion sensor (103) in a speed range between a start speed and a predetermined target speed using a predetermined assignment scheme, and adjust the fuel cell system (100) depending on the assigned state.

2. The fuel cell system (100) according to claim 1,
wherein
the controller (105) is configured so as to determine a gradient of the first and second order of the measured values detected in the speed range, and
the assignment scheme assigns respective values of the gradients of the first and second order to corresponding concentration values of hydrogen and/or water and/or nitrogen in the anode circuit.

3. The fuel cell system (100) according to claim 2,
wherein
the assignment scheme assigns a state “low hydrogen concentration” to respectively detected measured values when a gradient of the first order of the measured values lies above a predetermined first gradient threshold and a gradient of the second order of the measured values lies below a predetermined second gradient threshold, and
the assignment scheme assigns a state “average hydrogen concentration” to respectively detected measured values when the gradient of the second order of the measured values in a speed range takes on values in a speed range that are 50% less than the target speed, which are less than zero and greater than a predetermined negative threshold, and
the assignment scheme assigns a state “low hydrogen concentration” to respectively detected measured values when the gradient of the second order of the measured values takes on values in the speed range that are 50% less than the target speed, which are lower than the negative threshold.

4. The fuel cell system (100) according to claim 1,
wherein
the controller (105) is configured so as to actuate a purge valve (107) of the fuel cell system (100) depending on a detected state of a composition of matter.

5. The fuel cell system (100) according to claim 4,
wherein
the assignment scheme assigns a state “water in the anode circuit” to the detected measured values when values of a gradient of the first order of the detected measured values fluctuate between positive and negative values, and that the controller (105) is configured so as to actuate the purge valve such that the purge valve (107) periodically opens and closes in the event that the assignment scheme assigns the state “water in the anode circuit” to the respective measured values.

6. The fuel cell system (100) according to claim 4,
wherein
the controller (105) is configured so as to open the purge valve (107) continuously until the target speed of the blower (101) is reached in the event that the assignment scheme assigns the state “low hydrogen concentration in the anode circuit” to the detected measured values.

7. The fuel cell system (100) according to claim 1,
wherein
the motion sensor (103) is a speed sensor and/or torque sensor for determining a momentum applied to the blower.

8. The fuel cell system (100) according to claim 1,
wherein
that the assignment scheme assigns a state “iced purge valve” to the detected measured values when values of a gradient of the second order of the detected measured values lie below a predetermined purge threshold after a purging operation.

9. A method (300) for operating a fuel cell system (100),
wherein the method (300) comprises:
a determining step (301) for detecting measured values of a movement of a paddle wheel of a blower (101) of the fuel cell system (100) for conveying anode gas in a speed range between a start speed and a predetermined target speed, by means of a motion sensor (103),
an assigning step (303) for assigning measured values detected by the motion sensor (103) in the speed range to a state of a composition of matter in an anode circuit of the fuel cell system (100) using a predetermined assignment scheme, and
an adjusting step (305) for adjusting the fuel cell system (100) depending on the state assigned in the assignment step (303).

10. The method (300) according to claim 9,
wherein
the adjusting step (305) includes an actuation of a purge valve (107) of the fuel cell system (100).
